(19) United States
(12) Patent Application Publication
(10) Pub. No.: US 2012/0119908 A1
(43) Pub. Date: May 17, 2012

(54) COMMUNICATIONS-PAIRED EMERGENCY INFORMATION CONTAINER

(76) Inventor: Tamara A. Clark, Gregory, MI (US)

(21) Appl. No.: 13/358,654

(22) Filed: Jan. 26, 2012

Related U.S. Application Data
(63) Continuation-in-part of application No. 12/002,852, filed on Dec. 19, 2007, now Pat. No. 8,132,711.

(51) Int. Cl. G08B 21/18

(52) U.S. Cl. 340/568.1

(57) ABSTRACT

A system and method for pairing an emergency information container to communications technology. A sensor for signals when the emergency information container is placed on or removed from a location and an interface allows a user to input the name of the person identified in the emergency information container as well as one or more emergency contact numbers. A communications device is included that is able to communicate with the one or more emergency contact numbers, and a control system receives signals from the sensor that indicate when an emergency information container is placed on or removed from the location. The control system utilizes the interface to receive and store the name of the person identified in the container and the one or more emergency contact numbers, and the control system utilizes the communications device to contact the one or more emergency contact numbers.

This application is a Continuation-In-Part of and claims benefits from copending U.S. patent application Ser. No. 12/002,852, filed Dec. 19, 2007, which is incorporated by reference herein in its entirety.

### BACKGROUND OF THE INVENTION

1. Field of the Invention

This invention relates generally to a system and method for providing an emergency information container that is paired to a communications device and, more particularly, to a system and method for providing an emergency information container that is paired to a communications device such that the communications device sends a signal when the emergency information container is removed from the surface to which it is affixed.

2. Discussion of the Related Art

In life it is important to take calculated risks. For example, parents, those caring for persons with special needs and the elderly need to be prepared in the event an emergency arises. People tend to assume “nothing will happen” or, even if they carefully convey and/or listen to emergency instructions, when an emergency arises people tend to become frazzled and may fail to recollect the information accurately or may forget where the information is placed. Because the risk of an accident or medical emergency is always present, there is a need for a simple way to have information available, yet private until needed.

The conventional practice of carrying identification and other personal or medical information on a person, e.g., in a wallet or a purse, is grossly inadequate for children, persons with special needs and sometimes the elderly. Passing such information from one caregiver to the next is equally inadequate, particularly in situations where one caregiver may be authorized to make emergency medical treatment decisions while another caregiver is not.

In certain circumstances, if an adult and an infant are involved in an automobile accident, and the adult is unconscious or otherwise incoherent, emergency personnel have no way of knowing whether or not the child is the child of the adult. Emergency personnel also have no way of knowing if the child or the adult have specific medical conditions such as allergies or chronic conditions. In other circumstances, an elderly person who is still able to drive may benefit by affixing emergency information to a location on their driver seat that emergency personnel can access if needed. A driver of any age may benefit from keeping emergency information readily available, yet private, until needed. Maintaining the emergency information private by sealing the information inside a container, as described in copending U.S. patent application Ser. No. 12/002,852 entitled “Emergency Information Container” incorporated herein by reference, reduces the risk of exposing sensitive information except in those situations where it is necessary to do so. The emergency information container incorporated herein by reference allows for comprehensive information and a photo to be included to ensure that all relevant information may be available in the event an emergency arises. Including a photo or photos allows emergency personnel to be sure the information they have correlates to the person involved in the emergency by allowing a comparison between the photo and the person.

While the emergency information container incorporated herein by reference provides an opportunity to keep emergency information available, yet private until needed, there is a need in the art to pair each emergency information container to a communications device. By pairing the emergency information container to a communications device such as a vehicle communications system or a cellular phone, emergency contact persons may be notified as soon as the emergency information container is opened and/or removed from the surface to which it is affixed.

### SUMMARY OF THE INVENTION

In accordance with the teachings of the present invention, a system and method are disclosed for pairing an emergency information container to communications technology that includes a sensor for sensing when the emergency information container is placed on or removed from a location and an interface that allows a user to input the name of the person identified in the emergency information container as well as one or more emergency contact numbers. A communications device is included that is able to communicate with the one or more emergency contact numbers, and a control system is configured to receive signals from the sensor that indicate when an emergency information container is placed on or removed from the location. The control system utilizes the interface to receive and store the name of the person identified in the container and the one or more emergency contact numbers, and the control system utilizes the communications device to contact the one or more emergency contact numbers.

Additional features of the present invention will become apparent from the following description and appended claims, taken in conjunction with the accompanying drawings.

### BRIEF DESCRIPTION OF THE DRAWINGS

FIG. 1 is a schematic diagram of a front-side view of an emergency information container;

FIG. 2 is a schematic diagram of a rear-side view of the emergency information container;

FIG. 3 is a block diagram of a vehicle with a seat that includes an emergency information container;

FIG. 4 is an exploded view of a seat in a vehicle; and

FIG. 5 is a flow diagram for using an emergency information container in a vehicle.

### DETAILED DESCRIPTION OF THE EMBODIMENTS

The following discussion of the embodiments of the invention directed to a system and method for providing an emergency information container that is paired to a communications device is merely exemplary in nature, and is in no way intended to limit the invention or its applications or uses.

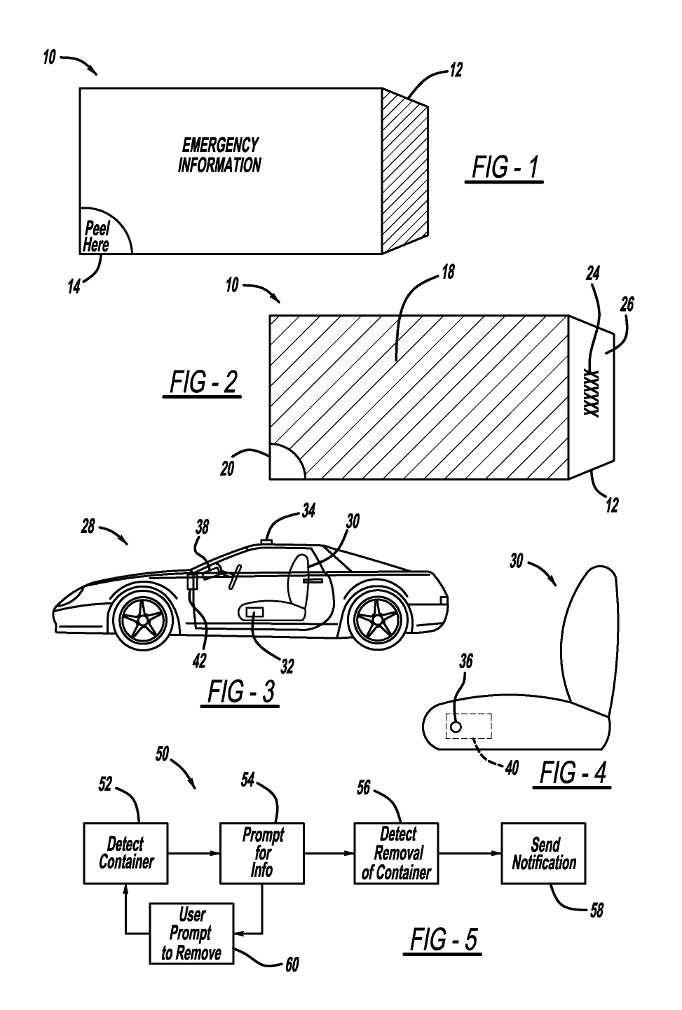

FIG. 1 is a schematic diagram of a front-side view of an emergency information container 10. The container 10 includes a flap 12 that has an adhesive on a top surface. A corner 14 of the container 10 is designated as the area to grasp and remove the container 10 from a surface to which it is affixed, as is discussed in more detail below. The front-side of the container includes a word or words that alerts rescuers that emergency information is inside of the container 10. A more thorough description of the emergency information container 10 can be found in copending U.S. patent application Ser. No. 12/002,852 entitled, “Emergency Information Container”, filed Dec. 19, 2007 and incorporated herein by reference.

FIG. 2 is a schematic diagram of a rear-side view of the emergency information container 10. Adhesive 18 covers a portion of the rear-side of the container 10, except a corner 20 that corresponds to the corner 14 of the front-side view is not covered with adhesive to ensure that the corner 14 can be grasped and pulled to remove the container 10 from a surface to which it is affixed. An adhesive 24 that is less tacky than the adhesive 18 covers a rear side 26 of the flap 12.

FIG. 3 is a block diagram of a vehicle 28 with a seat 30 and an emergency information container 32 affixed to the seat 30. The vehicle 28 also includes a control system 42, a communications device 34 and a display 38. As is known to those skilled in the art, the communications device 34 may be paired with a wireless communications device such as a cellular phone. The display 38 is used to allow a user to input one or more emergency contact numbers and the name of the person to whom the emergency information belongs into a memory of the control system 42. The one or more emergency contact numbers are called and notified via voice and/or text that the emergency information container 10 belonging to the particular person to which it is assigned has been accessed using the control system 42 and the communications device 34 as is discussed in more detail below.

FIG. 4 is an exploded view of the seat 30 of the vehicle 28. The dashed line 40 represents the outline of an emergency information container 10. A sensor 36 is placed within the dashed line 40 to enable the sensor 36 to detect when an emergency information container 10 is placed on the seat 30 and when the container 10 is thereafter removed from the seat 30 in a manner that is well understood by those skilled in the art. For example, when an emergency information container 10 is affixed to the driver's seat 30, the sensor 36 detects that a container 10 has been affixed and sends a signal to the control system 42. The control system 42 utilizes the interface 38 to prompt the user to enter the name of the person whose emergency information is in the container 10 and one or more emergency contact numbers that are stored in a memory of the control system 42. If the sensor 36 thereafter detects that the container 10 has been removed, the sensor 36 will send a signal to the control system 42. The control system 42 will then utilize the communications device 34 to contact the one or more emergency contact numbers and will convey a message, via voice or text, indicating the name of the person associated with the container 10 and that the container 10 has been removed from the seat 30 to which it was previously affixed. While a driver's seat is used in the above example, each seat in a vehicle may be equipped with a sensor for detecting an emergency information container in the manner described above. Additionally, the control system 42 may also transmit the location of the vehicle 28 at the time the container 10 was removed from the seat 30 to the one or more emergency contact nurnber(s) if the vehicle is equipped with a global positioning system.

FIG. 5 is a flow diagram of an algorithm 50 for using the emergency information container 10 in the vehicle 28. At box 52, the sensor 36 detects that the container 10 has been affixed to the seat 30 and sends a signal to the control system 42 in a manner that is well understood by those skilled in the art. As stated above, each seat in the vehicle 28 may be equipped with a sensor such as the sensor 36 to enable an emergency information container to be affixed to each seat. This is particularly useful for seats that are used to transport infants and children because families typically place each child's carseat or booster seat in one location in a vehicle, i.e., a designated seat is typically used for each person.

At box 54 the control system 42 receives the signal from the sensor 36 that indicates that the emergency information container 10 has been affixed to a seat 30, and the control system 42 utilizes the interface 38 to prompt the user to use the interface 38 to input the name of the person that is identified in the container 10 along with one or more numbers of contact person(s) that are to be notified if the emergency information container 10 is later accessed, i.e., removed. The control system 42 then stores the information inputted by the user in a memory of the control system 42. When the sensor 36 detects that the container has been removed at box 56, the control system 42 uses the communication device 34 to send a voice and/or text notification to the number(s) of the contact person(s) provided for that particular container 10 that notifies the contact person(s) that the emergency information for the person specified for that particular container 10 has been accessed at box 58. This allows the emergency contact person to be immediately notified that an emergency may have occurred so that they may take appropriate action.

As stated above, the notification sent at the box 58 may also include the location of the vehicle 28 at the time the emergency information container 10 was accessed to enable the contact person to arrive at that location. Notification both with and without location information enables a person or persons that are authorized to make emergency medical decision to be available to do so, or simply to be available to provide additional information and/or moral support.

Alternatively, if emergency information needs to be replaced prior to the information being accessed for emergency purposes, at box 60 a user may use the interface 38 to notify the control system 42 that the emergency information container 10 will be removed for reasons other than an emergency, e.g., to update and replace the container 10. Once the user utilizes the interface 38 to signal that the container 10 will be removed, the container 10 may be removed without a notification being sent to the emergency contact number(s). Once the control system 42 receives the signal the control system 42 will send a signal to the interface 38 indicating that the container 10 may be removed for non-emergency reasons. Once the user removes the container 10 the algorithm returns to the box 52 when a new emergency information container 10 is detected on the seat 30 as described above. Although not shown for the sake of clarity, the user may also utilize the interface 38 to update emergency contact numbers without removing the container 10.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for pairing an emergency information container to communications technology, said system comprising:
a sensor for sensing when the emergency information container is placed on or removed from a location;
an interface, said interface allowing a user to input the name of a person that is identified in the emergency information container and that also allows a user to input one or more emergency contact numbers;
a communications device, said communications device able to communicate with the one or more emergency contact numbers; and
a control system, said control system configured to receive signals from the sensor that indicate when an emergency information container is placed on or removed from the location, said control system also configured to utilize the interface to receive and store the name of the person identified in the container and the one or more emergency contact numbers when the sensor signals that the container is placed on the location, said control system utilizing the communications device to contact the one or more emergency contact numbers when the sensor signals that the container has been removed from the location.

2. The system according to claim 1 wherein the control system sends a voice and/or text message to the emergency contact numbers indicating that the container has been accessed and the name of the person associated with the person identified in the container when the sensor signals that the container has been removed from the location.

3. The system according to claim 2 further comprising that the control system sends information regarding the location of the system to the emergency contact numbers when the sensor signals that the container has been removed from the location.

4. The system according to claim 1 wherein the emergency information container is located on a seat in a vehicle.

5. The system according to claim 1 wherein the control system stores the name of the person identified in the container and the one or more emergency contact numbers in a memory of the control system.

6. The system according to claim 1 further comprising that the user utilizing the interface indicates to the control system that the emergency information container will be replaced when it is desirable to do so such that the emergency information container can be removed without the emergency contact numbers being notified.

7. The system according to claim 1 further comprising that the user utilizes the interface to update the emergency contact numbers that are stored in the control system.

8. A system for pairing an emergency information container to communications technology on a vehicle, said system comprising:
a sensor for signaling when the emergency information container is placed on or removed from a location on the vehicle;
an interface, said interface allowing a user to input the name of a person that is identified in the emergency information container and that also allows a user to input one or more emergency contact numbers;
a communications device, said communications device capable of communicating with the one or more emergency contact numbers; and
a control system, said control system configured to receive a signal from the sensor that indicates when the emergency information container is placed on or removed from the location on the vehicle, said control system further configured to utilize the interface to receive and store the name of the person identified in the container and to receive the one or more emergency contact numbers when the sensor signal indicates that the container has been placed on the location on the vehicle, said control system utilizing the communications device to contact the one or more emergency contact numbers when the sensor signal indicates that the container has been removed from the location.

9. The system according to claim 8 wherein the control system sends a voice and/or text message to the emergency contact numbers indicating that the container has been accessed and the name of the person associated with the container when the sensor signal indicates that the container has been removed.

10. The system according to claim 9 further comprising that the control system sends information regarding the location of the vehicle when the sensor signals that the container has been removed.

11. The system according to claim 8 wherein each seat in the vehicle includes a sensor for sensing when an emergency information container is placed on or removed from the location that is a seat in the vehicle.

12. The system according to claim 11 wherein the control system stores the name of the person identified in each container in the vehicle and the one or more emergency contact numbers associated with each container in a memory of the control system.

13. The system according to claim 8 further comprising that the user utilizes the interface to allow the emergency information container to be replaced without contacting the emergency contact numbers.

14. The system according to claim 8 further comprising that the user utilizes the interface to update the emergency contact numbers that are stored in the control system.

15. A method for pairing an emergency information container to communications technology in a vehicle, said method comprising:
providing a sensor, said sensor signaling when the emergency information container is placed on or removed from a location in the vehicle;
providing an interface, said interface allowing a user to input the name of a person that is identified in the emergency information container and that also allows a user to input one or more emergency contact numbers;
providing a communications device, said communications device capable of communicating with the one or more emergency contact numbers; and
providing a control system, said control system receiving a signal from the sensor when the emergency information container is placed on or removed from the location on the vehicle, said control system utilizing the interface to receive and store the name of the person identified in the container and to receive the one or more emergency contact numbers when the sensor signals that the container has been placed on the location on the vehicle, said control system utilizing the communications device to contact the one or more emergency contact numbers when the sensor sends a signal indicating that the container has been removed.

16. The method according to claim 15 wherein the control system sends a voice and/or text message to the emergency contact numbers indicating that the container has been accessed and the name of the person associated with the container when the sensor signals that the container has been removed.

17. The method according to claim 16 further comprising that the control system sends information regarding the location of the vehicle when the sensor signal indicates that the container has been removed.

18. The method according to claim 15 wherein each seat in the vehicle includes a sensor for sensing when an emergency information container is placed on or removed from the seat to which it is affixed, and the control system stores the name of the person identified in each container and the one or more emergency contact numbers associated with each container in the vehicle in a memory of the control system.

19. The method according to claim 15 further comprising that the user utilizes the interface to allow the emergency information container to be replaced without contacting the emergency contact numbers.

20. The method according to claim 15 further comprising that the user utilizes the interface to update the emergency contact numbers that are stored in the control system.
